(19) United States
(12) Patent Application Publication
(10) Pub. No.: US 2005/0233869 A1
(43) Pub. Date: Oct. 20, 2005

(54) Spring component structure of a hopper for fitness use

(76) Inventor: Yan- Yee Lee, Taichung Hsien (TW)

Correspondence Address: John S. Egbert;Harrison & Egbert, 7th Floor, 412 Main Street, Houston, TX, 77002, US

(21) Appl. No.: 10/977,835

(22) Filed: Nov. 1, 2004

(30) Foreign Application Priority Data
Apr. 15, 2004 (TW) 093205811

(51) Int. Cl. A63B 25/08; H01H 9/00; A63B 26/00

(52) U.S. Cl. 482/77

(57) ABSTRACT

A hopper includes a handrail, a treadle, and a spring component, which is installed at the bottom of the hopper and touches the ground. The treadle is placed above the spring component and the handrail is place above the treadle and extends upward. The spring component has upper and lower arc boards and an auxiliary spring component. The upper and the lower arc boards assemble together to form a spring frame. The top of the upper arc board is fixed with the treadle and the lower arc board meets the ground. The auxiliary spring component is placed between the upper and lower arc boards to enhance the spring force of the arc boards as well as structural strength.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a hopper for fitness purposes, and more particularly to a hopper which is comprised with upper and lower arc boards, and auxiliary spring components.

### BACKGROUND OF THE INVENTION

Traditional hopper is well known to us. It has an erecting pole, on the top of which there is a T type handrail and the other end is a column touching the ground. At certain height from the end there is a treadle for a user to step on. Between the treadle and the touching end, there is a spring, which pulls the treadle back to place. However, due to the limited touching area between the hopper and the ground, this traditional hopper requires excellent balance, which is quite different for learners and common users. They would lose interest in the hopper as they cannot jump on it for a long period. Therefore, a new hopper for fitness purpose, which is suitable for common users to jump for long time, has become the goal for manufacturers to improve.

### BRIEF SUMMARY OF THE INVENTION

The improvements of this invention are:

1. Provide a spring component, which is composed of upper and lower arc boards as well as auxiliary spring component, to new hopper.

2. With this improvement, a new hopper, which is easy to control with greater touching area, is made possible for learners and common users.

### BRIEF DESCRIPTION OF THE SEVERAL VIEWS OF THE DRAWINGS

FIG. 1 shows a perspective view of the preferred embodiment of the present invention.

FIGS. 2-3 show the schematic diagram of the preferred embodiment of the present invention.

FIGS. 4-6 show other schematic diagrams of the present invention.

FIG. 7 shows a schematic diagram of the horizontal board in FIG. 6.

FIG. 8 shows another schematic diagram of the auxiliary spring component of the present invention.

FIG. 9 shows a plane diagram of the installed structure of FIG. 8.

FIG. 10 shows another schematic diagram of the installed structure of FIG. 8.

FIG. 11 shows another schematic diagram of the installed structure of upper and lower arc boards.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

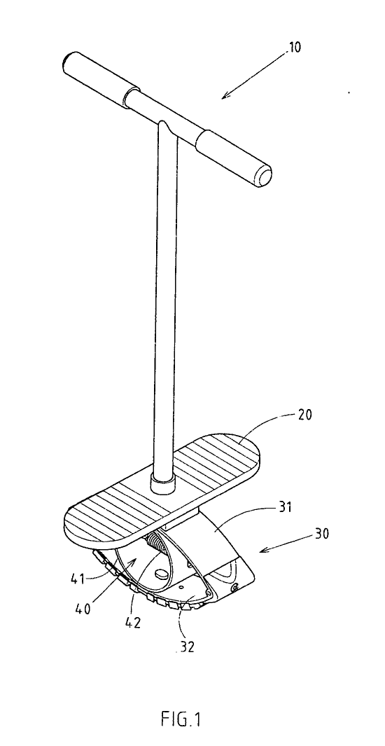

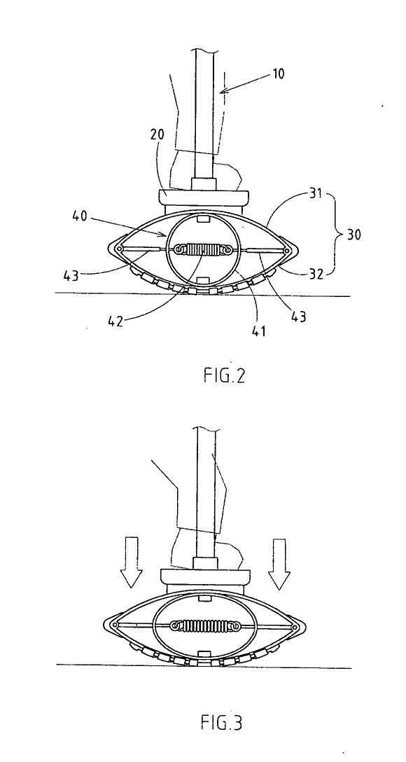

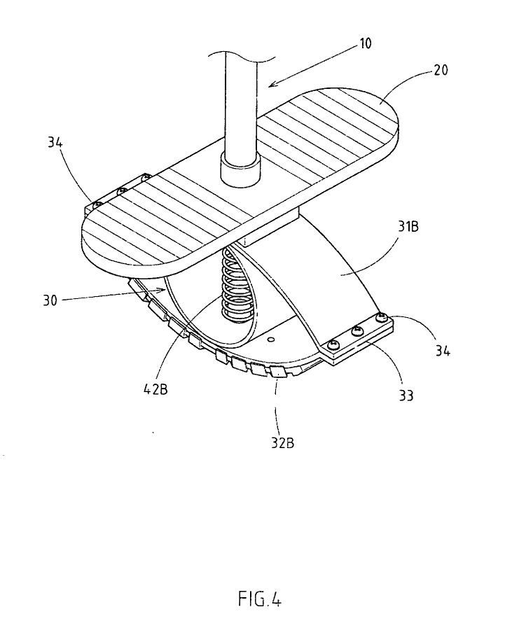

As shown in FIGS. 1-2, a hopper embodied in the present invention comprises:

a handrail 10, a treadle 20 and a spring component 30; where the spring component 30 is installed at the end of the hopper to touch down on the ground. The treadle 20 is placed above the spring component 30, on which the user can put his/her feet. The handrail 10 is installed above the treadle 20 and extends upward. It features:

The spring component 30 is composed of upper arc board 31, lower arc board 32 and auxiliary spring component 40. The upper and lower arc boards 31 32 constitute a spring frame. The upper end of the upper arc board 31 is assembled with the treadle 20 by screws. The lower arc board 32 touches the ground at the bottom face. The spring frame formed by the upper and lower arc boards 31 32 would spring backward as the treadle 20 pushes it. This auxiliary spring component 30 is placed between the upper and lower arc boards 31 32 to enhance the spring force and the structural strength of the two arc boards.

As shown in FIG. 1, the upper and the lower arc boards 31 32 can be integrated part.

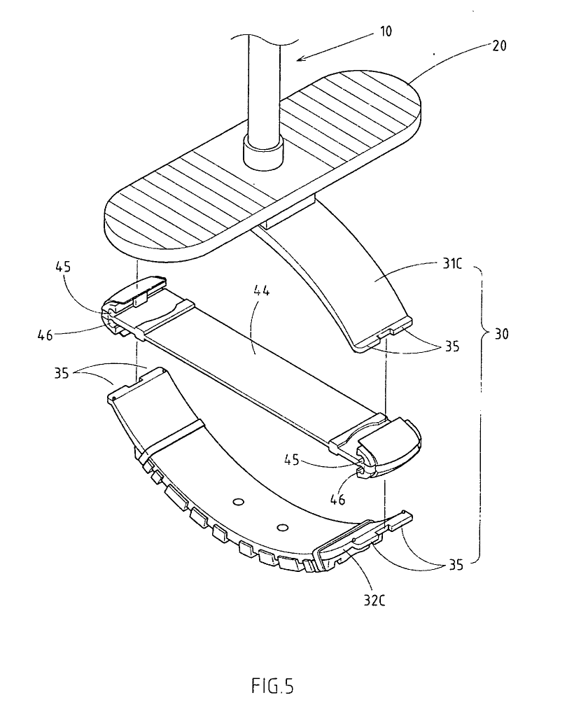

As shown in FIG. 4, the upper and lower arc boards 31 32 can be two separate parts. Both their two ends can be shaped as meeting face 33 to meet together and fixed by fixing component 34 (such as screws).

As shown in FIG. 1, the auxiliary spring component 40 can be a round spring frame 41 matched with a horizontal spring 42. This round spring frame 41 is placed within the frame formed by the upper and lower arc boards 31 32. Both ends of the spring 42 are respectively connected with the horizontal ends of the upper and lower arc boards 31 32. The ends of spring 42 can be hooked on pin 43, which is located at the both ends of the upper and lower arc boards 31 32.

As shown in FIG. 4, the spring 42B can also be hooked vertically.

As shown in FIG. 5, the auxiliary spring component can also be a horizontal board 44. On both ends of it there are upper and lower fixing grooves 45 46, which can meet fit and fix the bolts 35 located at the horizontal ends of the upper and lower arc boards 31C 32C.

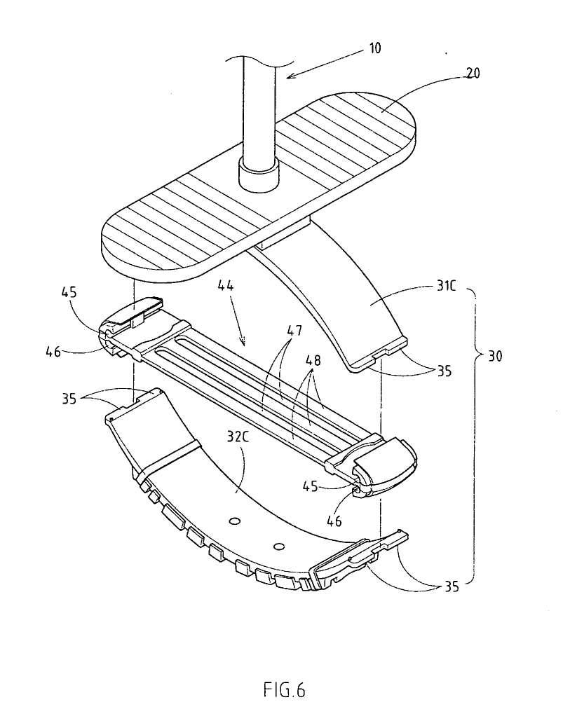

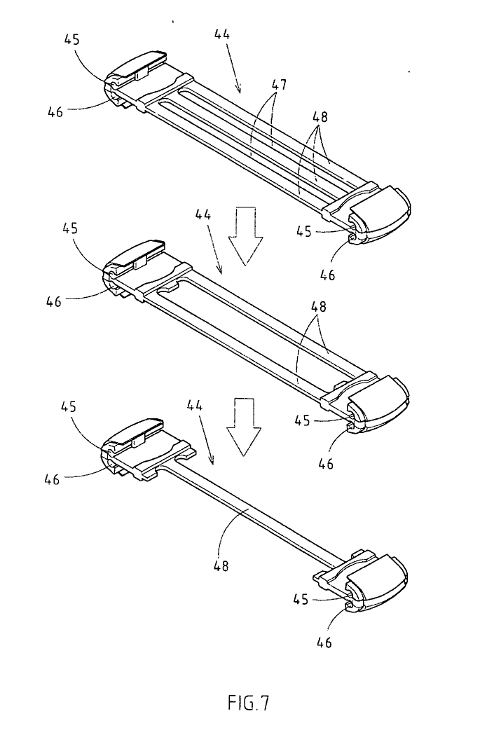

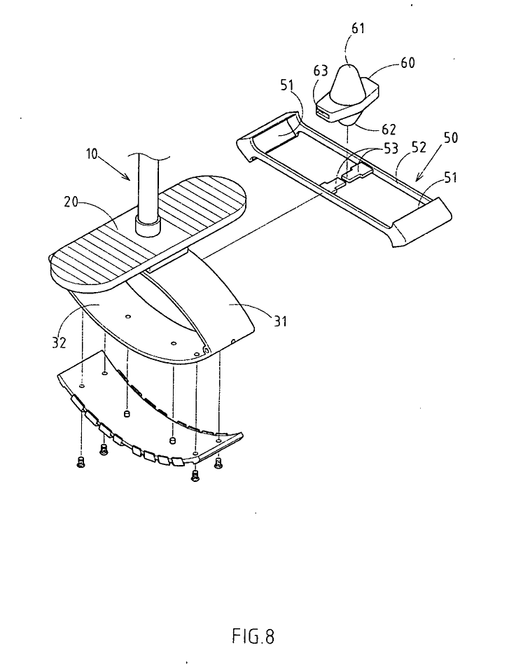

As shown in FIG. 6, in the middle of the horizontal board 44 there can be set a long-interval through groove 47, by which several separate springs 48 can be formed. Therefore the springs can be reduced and the spring force can be adjusted (refer to FIG. 7), the fewer the springs 48 are, the smaller the spring force is.

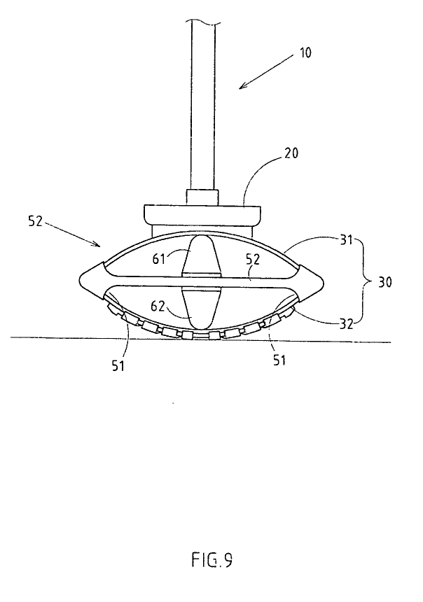

As shown in FIGS. 8 and 9, this auxiliary spring component can be a rectangular spring frame 50. On both ends of the longer side there are concave grooves 51, which can fit into both ends of the upper and lower arc boards 31 32. On the shorter side there are bulging parts 53 corresponding with the two side-frame 52. Furthermore, a spring block 60 is formed on both sides of which there is a concave part 63, which can fit into the bulging parts 53. The upper and lower ends 61 62 of the spring block 60 bear the upper and lower arc boards 31 32 and provides the auxiliary spring force as the upper and lower arc boards are pushed.

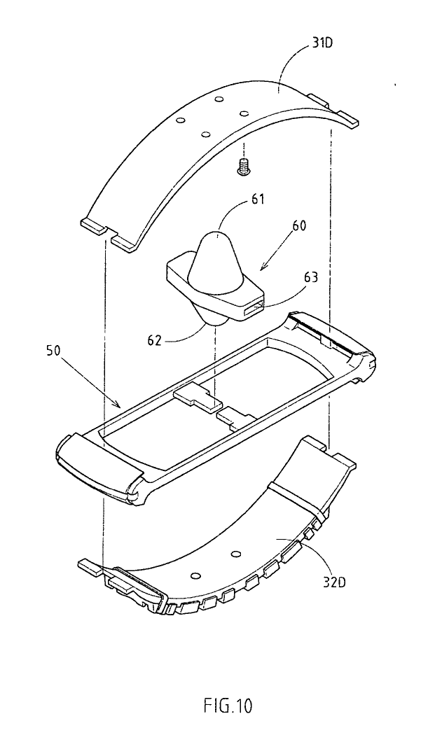

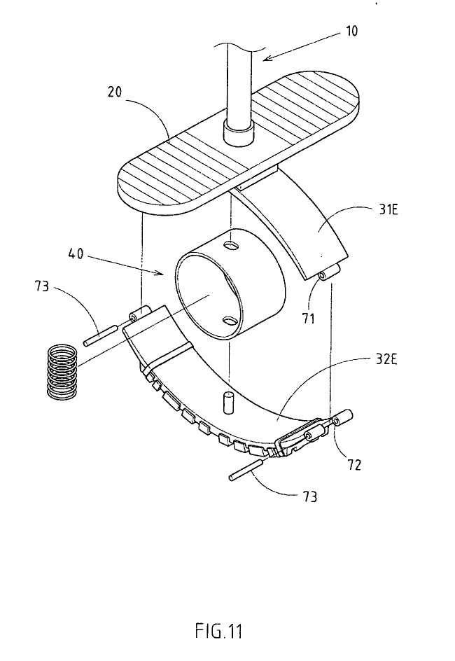

As shown in FIG. 10, which is a sequel to FIG. 8 and FIG. 9, the upper and lower arc boards 31D 32D can be two separate components, which is connected with the spring frame 50 by blocking into it (as shown in FIG. 5).

As shown in FIG. 4, both ends of the upper and lower arc boards 31E 32E may have corresponding through-holes 71 72 as shown in FIG. 11, which can be assembled by bolts 73.

Furthermore, the newly invented spring component 30, which is composed of upper arc board 31, lower arc board 32, and auxiliary spring component 40, can also be applied to other pedal fitness equipments, such as saddle and fitness bicycle, to achieve the same spring force as this case.

1. A hopper for fitness purposes comprising:
a treadle;
a handrail, installed above the treadle and extended upwards; and
a spring component installed at a bottom of said treadle,
said spring component being comprised of an upper arc board, lower arc board and auxiliary spring component, the upper and lower arc boards forming a spring frame, an upper end of the upper arc board being assembled with said treadle by screws, said lower arc board touching ground at a bottom face thereof, said spring frame being springable backward as pushed by said treadle, said spring component being placed between the upper and lower arc boards.

2. The hopper defined in claim 1, wherein the upper and the lower arc boards are integrally formed.

3. The hopper defined in claim 1, wherein the upper and lower arc boards are formed by two separate parts, wherein ends thereof are shaped as meeting face to meet together and fixed by a fixing component.

4. The hopper defined in claim 1, wherein said spring component is a round spring frame matched with a horizontal spring, said round spacing frame placed within said spring frame, both ends of the horizontal spring respectively connected to horizontal ends of the upper and lower arc boards.

5. The hopper defined in claim 4, wherein said horizontal spring is installed vertically.

6. The hopper defined in claim 1, wherein said spring component is comprised of a horizontal board, both ends thereof having upper and lower fixing grooves, engageable, fittable and fixable to bolts located at horizontal ends of the upper and lower arc boards.

7. The hopper defined in claim 6, wherein said horizontal board is comprised of a long-interval through groove in a middle thereof, forming several separate springs, the separate springs being reducible and adjustable.

8. The hopper defined in claim 1, wherein said spring component is comprised of a rectangle spring frame, having concave grooves on both ends of a longer side thereof, said concave grooves being fittable into both ends of the upper and lower arc boards, and having bulging parts on a shorter side thereof, said bulging parts corresponding to a two side-frame, wherein a spring block is formed on both sides of a concave part, being fittable into the bulging parts, upper and lower ends of the spring block bearing the upper and lower arc boards and providing auxiliary spring force as the upper and lower arc boards are pushed.
